(19) United States
(12) Patent Application Publication
(10) Pub. No.: US 2006/0122995 A1
(43) Pub. Date: Jun. 8, 2006

(54) Searching method of position information and searching system thereof

(75) Inventors: Hirotoshi Shimizu, Kawasaki (JP); Keiji Nibe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/337,486

(22) Filed: Jan. 24, 2006

Related U.S. Application Data
(63) Continuation of application No. PCT/JP03/11145, filed on Sep. 1, 2003.

(51) Int. Cl. G06F 7/00; G06F 17/30

(52) U.S. Cl. 707/4

(57) ABSTRACT

A searching method and system of position information search position information through the medium of image data of an identification mark attached to construction products such as a post box, a telephone booth and a utility pole, and a tree. Image data of the identification mark on an object is acquired by using a mobile terminal device or the like and an identification code is read from this image data and notified. Position information is searched by this identification code, and this position information is notified to the mobile terminal device or the like.

### CROSS-REFERENCE TO RELATED APPLICATIONS

This application is a continuation of International Application No. PCT/JP2003/011145, filed on Sep. 1, 2003, now pending, herein incorporated by reference.

### BACKGROUND OF THE INVENTION

1. Field of the Invention

The present invention relates to a position information search for searching position information from an identification mark attached to a tree or construction product such as a post box, a telephone booth, a telephone booth and a utility pole. Especially, the present invention relates to a searching method and searching system of position information through the medium of image information of identification mark by using a device such as a mobile terminal device with a camera.

2. Description of the Related Art

Conventionally, a searching method of position information using Global Positioning System (hereafter GPS) is known to. In this searching method of position information, it is difficult or impossible to search position information at a place where a GPS radio wave is not receivable from a satellite, for example, places with a shielding object such as indoor place, buildings, and subway platforms.

To use GPS function in a mobile phone device as a mobile station leads to a increase of power consumption of the device by accompanying high-speed processing, and leads to a increase of power consumption of an embedded secondary battery. In addition, using a dedicated chip to receive GPS radio wave makes an increase in a product cost inevitable.

Referring to such arts for receiving position information, Japanese Patent Application Laid-open Publications No. 2000-205888, H10(1998)-105889, H05(1993)-025809, and 2000-358105 are disclosed.

In the publication No. 2000-205888, a method and device of position/direction information acquisition are disclosed, it is an object to provide the method and device of position/direction information acquisition which can easily acquire latitude/longitude and direction information to define a position on the earth uniquely at low cost even if at a place not to be able to receive radio wave from a satellite. In the structure, with a plurality of position information indicators for setting latitude/longitude information on a plurality of construction products and a position information reader for reading the latitude/longitude information shown in a position-information indicating position, present position information is acquired by reading latitude/longitude information from the position information indicator closest to the present position using the position information reader. With a direction information indicator installed in the vicinity in which the latitude/longitude information was set, direction information is acquired by reading the direction information from the direction information indicator closest to the present position.

In this method and device of position/direction information acquisition, position information is directly written in a bar-code or an optical character reader (OCR) to specify the present position instantly on a terminal. A label for that is needed, and accurate position information is needed prior to or for making up label. Making up and installation of such label are very troublesome. It is necessary to make up the position label again because position is changed in the case where the position label is relocated together with the construction product. In addition, if utility poles of an electric power company is assumed as an object for attaching the position labels on operation, it is necessary to acquire permission every time for the label attachment. It is impossible to respond to situation change of address change etc. In addition, in this method and device of position/direction information acquisition, it is impossible to receive related services for every label continuously since it is difficult to manage position information by a server.

In a car navigation system disclosed in the publication No. H10(1998)-105889, it is an object to map various information on a map to inform a driver through a car allocation center. The various information include position information of a user (passenger), its incidental information and effective information to guide route to the destination. Provided are position information acquisition means (hand entering, wireless, optical systems, bar-code, GPS etc.) for taking user own position information; a mobile terminal device having an input means for entering incidental information of the user; a car allocation center for performing instruction, confirmation, management and so on for taxi allocation; a communication means for receiving position information of a user and its incidental information from the car allocation center; and a reservation firming means for user to firm reservation for the car allocation center. The car navigation system is structured by car navigation for indicating the present position on the map and the incidental information.

It is an object of this car navigation system to provide services for passengers. Position information is not returned to a client (requester) of the position information. Information is provided as an incidental service from the car allocation center, so it is difficult to provide a stable service. A service area of position information is narrow so that a nation-wide uniform position information cannot be provided. This system can not respond to position searching in a shielding object such as buildings.

In a communication system for guiding position of a moving vehicle on a road disclosed in the publication No. H05(1993)-025809, a scanner reads present position, place-name, course, and distance to a intersection, which are indicated by a bar-code on the road. Bar-code information read by the scanner is converted to character information and displayed on a display. According to running distance, the number of distance to the intersection displayed on the display is deducted one by one. A present date and time are given to the place-name read by the scanner, and transmitted to a specified telephone number set up beforehand at a fixed interval through Integrated Services Digital Network (ISDN) switching apparatus. Safety is improved since a road traffic sign will not be overlooked. It is possible to manage safety condition, present position, arrival time etc of a car without troubling a driver.

In the communication system for guiding position of a moving vehicle on a road, position information written in a label is converted into character information after the position information is read. However, it is impossible to charge based on the conversion operation. This system requires using the Internet. It is necessary to sign a member registration in advance before receiving the service. In this system too, it is difficult to manage position information by a server and impossible to receive related services for every label continuously.

In an information searching system disclosed in the publication No. 2000-358105, the system aims at simplifying key operations in the case where information services are received in a mobile terminal device. In the structure, provided is an information reading means such as a bar-code scanner etc. for a mobile terminal device.

In this information searching system, code written on objects is read and information conversion of the code is carried out on a server. It is just a point of sales (POS) management. In such a system, it is neither taught nor disclosed that nation-wide position information service is supplied on the basis of a label attached to objects specifying position.

Each of these techniques disclosed in the above publications is use of GPS technique. It is therefore impossible to search position information at a place where GPS radio wave cannot be received or under the environment where use of GPS is restricted. A dedicated chip and an antenna are necessary to receive GPS radio wave so that it costs so much to install them. The above publications do neither disclose such problems nor suggest solution of the problems.

### SUMMAMRY OF THE INVENTION

It is an object of the present invention to provide a position information search without using GPS communication for solving the above problems.

More specifically, it is an object of the present invention to realize the position information search by means of image data captured from identification marks attached to and trees and construction products such as mailboxes, telephone booths and utility poles.

In order to achieve the above object, according to the present invention there is provided a searching method of position information, comprising the steps of taking an image data of an identification mark attached to an object, and reading an identification code from said image data; searching position information based on said identification code; and transmitting said position information acquired by the search.

According to the above search method, the position information is information to specify the identification mark, for example, information such as latitude, longitude, altitude etc. to indicate a global position indicated by latitude, longitude, altitude etc. As for this position information, the information indicating the place where the object exists are managed, for example, by electricity companies or telephone companies if the object is a utility pole, by road-administrating organizations if the objects are various marks on road, and by administrating organizations of residence indication or trees if the object is a residence indication or a trees By taking the picture of the identification mark attached to the objects, an image data can be acquired, and an identification code is read based on this image data. The position of the identification mark can be specified and recognized, by searching position information based on this identification code, and by receiving notification of the position information.

In order to achieve the above object, the searching method of position information of the present invention may further comprise the step of searching related information of said position information based on said position information, and transmitting the search result. As information relating to position information, there are residence indication of the position, a weather forecast, map information, a living-related information, etc. Accompanied by the search of position information, obtaining such related information, supply of position information with high convenience can be received.

In order to achieve the above object, according to the present invention there is provided a searching system of position information using a mobile terminal device, comprising a mobile terminal device, which takes an image data of an identification mark attached to an object, reads an identification code from said image data and transmits said identification code; a position information search section, which searches position information based on said identification code transmitted from said mobile terminal device; and a transmitting section, which transmits said position information searched by said position information search section to said mobile terminal device. Also, existing car navigation data can be used.

According to the search system of the present invention, image data can be acquired by taking the picture of identification mark using a mobile phone having a camera function, and a digital camera. Identification code is read based on this image data; a position information search section searches a position information using the identification code. The searched position information is notified to the mobile terminal device through a communication section whereby a user can specify the position of the identification mark for assisting him to understand.

In order to achieve the above object, according to the present invention there is provided a searching system of position information, comprising a mobile terminal device, which takes an image data of an identification mark attached to an object, reads an identification code from said image data and transmits said identification code; a position information search section, which searches position information based on said identification code; and a base station, which transmits said identification code transmitted from said mobile terminal device to said position information search section, and receives said position information searched by said position information search section and transmits said position information to said mobile terminal device.

In order to achieve the above object, in the searching system of position information of the present invention, said position information may be indicated on a display unit of said mobile terminal device.

In order to achieve the above object, in the searching system of position information of the present invention, said position information may be able to be transferred together with information other than said position information from said mobile terminal device.

In order to achieve the above object, in the searching system of position information of the present invention, said position information may be converted into an address of homepage.

In order to achieve the above object, the searching system of position information of the present invention may further comprise a related information transmitting section, which searches related information based on said position information, and transmits the search result.

In order to achieve the above object, in the searching system of position information of the present invention, said position information search section may transmit billing information together with said searched position information to the base station.

In order to achieve the above object, according to the present invention there is provided a mobile terminal device, comprising an image processing section reading an identification code from an image data of an identification mark attached to an object; an information transmitting section transmitting said identification code read by said image processing section; and an information receiving section receiving position information searched on the basis of said identification code.

As described above, according to the searching method of position information and the searching system thereof, the following advantages and effects are obtained.

(1) GPS radio wave is not used in the present invention therefore position information can be searched at a place where GPS radio wave is unavailable areas. A product cost for position information search can be reduced because a dedicated chip and antenna are not necessary for receiving GPS radio wave.

(2) Existing broad position information of identification mark attached to products such as trees and construction products such as utility poles, telephone booths and postboxes can be used widely

(3) Search area of position information can be expanded by attaching identification mark to construction products and objects such as trees.

Objects, characteristics, and advantages of the present invention can be more clearly understood by referring to the attached drawings and each of embodiments of the present invention.

### BRIEF DESCRIPTION OF THE DRAWINGS

FIG. 1 is a block diagram showing an outline of a searching system of position information according to an embodiment of the present invention.

FIG. 2 is a perspective view showing taking a picture of an identification mark

FIG. 3 is a block diagram showing a configuration of each section of a searching system of position information according to an embodiment of the present invention.

FIG. 4 is a flow chart showing a searching process of position information.

FIG. 5 is a flow chart showing an image recognition process of an identification mark.

FIG. 6 is a flow chart continued from the flow chart in FIG. 5 showing an image recognition process of an identification mark.

FIG. 7 is a flowchart showing position search processing.

FIG. 8 is a perspective view showing a notebook personal computer according to an embodiment of the present invention.

FIG. 9 is a perspective view of an embodiment showing a personal digital assistant according to an embodiment of the present invention.

FIG. 10 is a perspective view of an embodiment showing a digital camera according to an embodiment of the present invention.

### DETAILED DESCRIPTION OF THE PREFERRED EMBODIMENTS

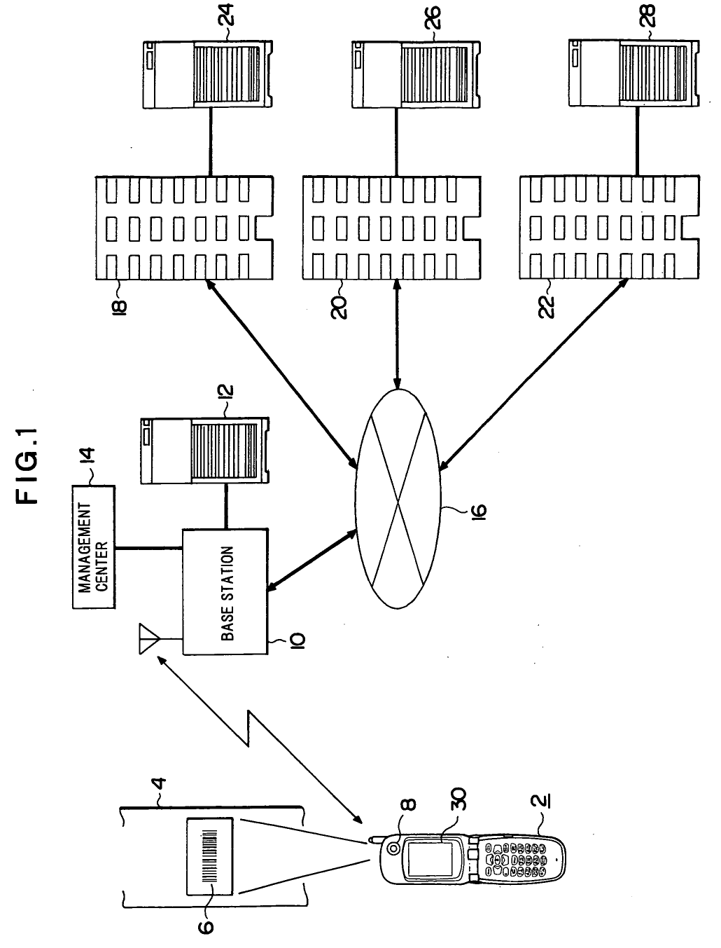

An embodiment according to a searching method of position information of the present invention and a searching system of position information thereof is described referring to FIG. 1. FIG. 1 shows a searching system of position information according to the embodiment.

In the searching method and system of position information, a mobile phone terminal (hereafter mobile terminal device) 2 as a mobile terminal has a structure to perform as an input section for taking an image data of identification mark 6 identifying position of a construction product 4, etc., and an output section for outputting the position information searched with the taking of the image data as a trigger. In this embodiment, an image input section 8 such as a camera is built in as an image sensor. As a mobile terminal device, a personal handy-phone system (PHS) terminal, a personal computer (PC), a personal digital assistant (PDA), and a digital camera can be used.

A base station 10 communicates with the mobile terminal device 2 through a telephone communication for receiving an identification code transmitted from the mobile terminal device 2. The base station 10 is connected with a position information conversion server 12 for storing position information data therein, and a management center 14 for operating various management operations including a billing operation for a telephone call. The position information conversion server 12 includes a database for storing position information. The base station 10 and the management center 14 are, for example, configured by existing telephone companies.

Also, the base station 10 is connected with a plurality of position information centers 18, 20, and an information-providing center 22 through an Internet network 16. Position information in the plurality of position information centers 18, 20 are utilized for making use of broad position information corresponding to various identification marks indicating positions. For example, the position information center 18 is a public organization such as the National Police Agency, and the position information center 20 is a profit organization such as an electricity company. Position information conversion servers 24, 26 are installed in the position information centers 18, 20, respectively, for storing position information data. Each of the conversion servers 24, 26 is configured with a database of position information.

The information-providing center 22 consists of organization managing various information such as position information and various information relating to the position information, for example, a map information, a weather information, a living-related information, and other information. An information server 28 is installed in the information-providing center 22 for storing the position information and various information relating to the position information. The information server 28 is also a database storing various information.

According to such configuration, an image data of the identification mark 6 attached to the construction products 4, etc. is taken in through the image input section 8 of the mobile terminal device 2. An identification code is read from the image data and transmitted to the base station 10. Thus, position information can be searched at the position information conversion server 12 on the base station 10 side. The identification code is transmitted from the base station 10 to the position information centers 18, 20 through the Internet network 16. Position information can be searched at the conversion server 24 of the position information center 18, the conversion server 26 of the position information center 20 or the information server 28 of the information-providing center 22.

In this case, the position information conversion servers 12, 24, 26 are referred to, depending on identification code type acquired by the mobile terminal device 2, for searching position information corresponding to the identification code. The position information is notified together with its billing information and other information to the base station 10 through the Internet network 16, and notified from the base station 10 received the position information to the mobile terminal device 2. The search result is displayed on a display unit 30 of the mobile terminal device 2. As for the notified position information, as other related information, there are residence indication of the position, weather information, map information, a living-related information, etc. Accompanied by search of position information, such related information can be acquired for utilizing.

Moreover, according to the searching system and the searching method, GPS radio wave is not used so that position information can be searched at a place where GPS radio wave is not receivable. A dedicated chip and an antenna are not necessary for receiving GPS radio wave therefore the cost of position information search can be lowered.

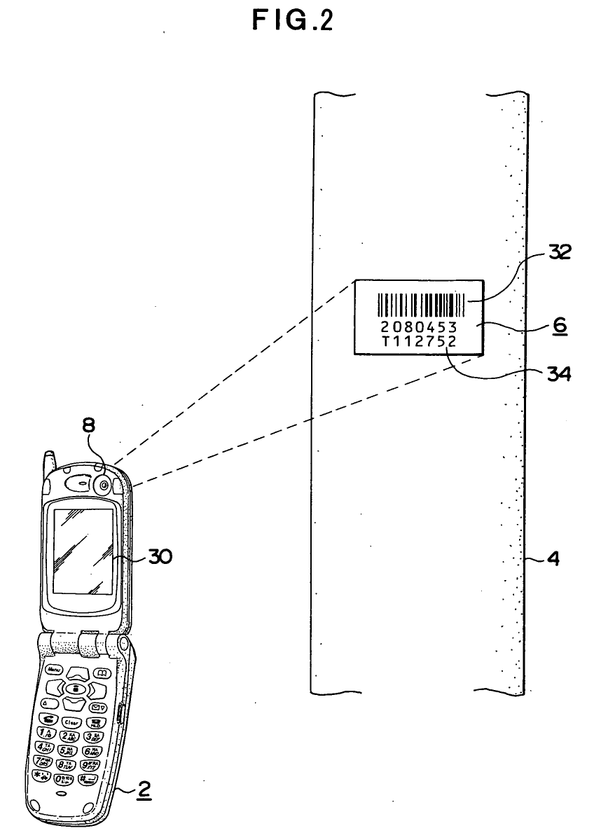

Next, an image data taken by the mobile terminal device 2 is described by referring to FIG. 2. FIG. 2 shows the taking a picture of an identification mark 6 on a construction product 4, etc by the mobile terminal device 2.

As examples of construction product 4, there are various objects in the city, such as traffic signs, utility poles, postboxes, vending machines, manholes, and buildings. Identification mark 6 is attached to trees in parks and street-trees for identifying their positions and administrators. This identification mark 6 is composed of a bar-code 32, characters 34, and other information such as bitmapped image.

In this case, the identification mark 6 has an identification code for identifying an administrator, etc. Information written in a bar-code to be attached are managed by administrator of an object to which the bar-code is attached. As administrators, for example, traffic signs are managed by the National Police Agency, power poles are managed by a local electricity companies, postboxes are managed by the Ministry of Posts and Telecommunications, manholes are managed by the waterworks department, and buildings are managed by map-making companies etc. It is only necessary to write in together an easily manageable unique code and an identification code identifying an administrator.

According to this configuration, it is possible to perform position search by making use of broad position information, by taking a picture of an identification mark 6 attached to the construction products 4 such as utility poles, telephone booths, postboxes, etc. and attached to objects like a trees so as to use as image data.

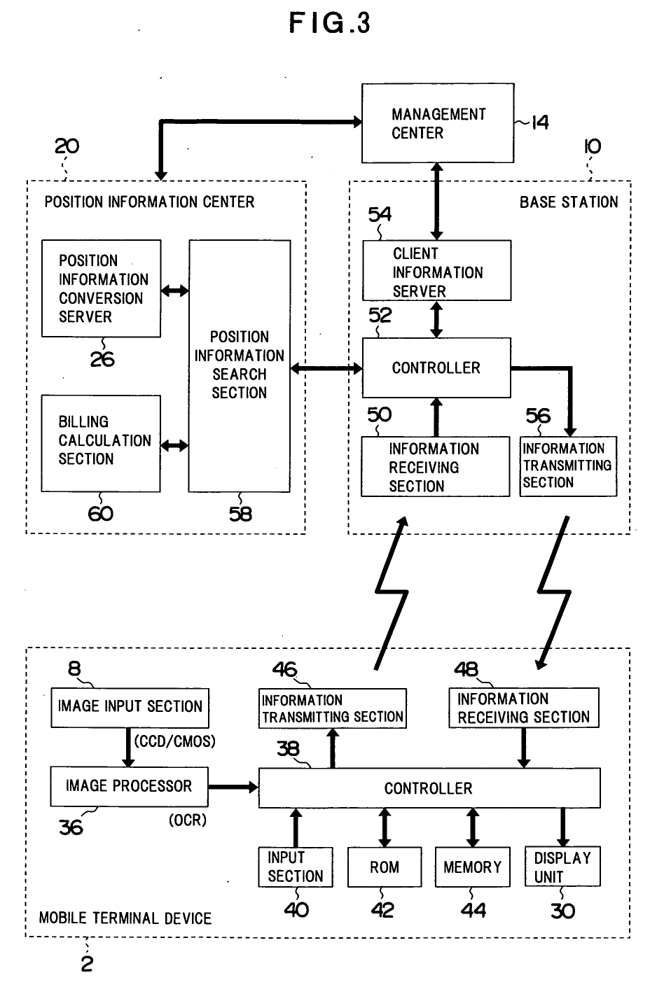

Next, an embodiment of a searching system of position information is described referring to FIG. 3. FIG. 3 shows an example of configuration of the mobile terminal device 2, the base station 10 and the position information centers 18 or 20.

In the mobile terminal device 2, the image input section 8 is an image capture function section taking in an image data of the identification mark 6 (FIG. 1, FIG. 2) by taking the picture. The image input section 8 can be comprised of a charge-coupled device (CCD) or a complementary metal-oxide semiconductor (CMOS). Also, it is possible to take in an image data as an external information without taking a picture by the mobile terminal device 2.

An image processor 36 has a function of a bar-code reader and an optical character reader (OCR) for recognizing characters and symbols from the image data captured from the image input section 8, etc. In other words, the image processor 36 is a code recognition section, information of bar-code etc. is converted into character information on the mobile terminal device 2 in order to reduce processing data.

A controller 38 is comprised of a central processing unit (CPU), the controller 38 is inputted of identification information such as telephone number etc. from an input section 40 such as a keyboard. A read only memory (ROM) 42 stores various control programs such as an image data-capture, an image processing, communication, data transmitting/receiving. A memory 44 stores an identification code taken in for position search and a search result. A liquid crystal display (LCD), etc. is used as a display unit 30 for displaying an inputted telephone number and position information as a search result. Identification code and client's specific data such as telephone number are transmitted from an information transmitting section 46 to the base station 10; a position information transmitted from the base station 10 is received by an information receiving section 48. In this case, the mobile terminal device 2 uses a wireless communication for transmitting/receiving; however, a wired communication can be used.

An information receiving section 50 of the base station 10 receives the identification code, the client's specific data, etc. transmitted from the information transmitting section 46 of the mobile terminal device 2. The identification code, etc. received by the information receiving section 50 is transferred to a controller 52, the client's specific data is referred to a client information server 54 to identify the client. The client is identified by a telephone number, an owner thereof, identification code, etc. of the mobile terminal device 2.

The controller 52 extracts a position code and an administrator code based on the identification code received, and specifies an administrator of the position information based on the administrator code. In this case, the administrator is specified from a connectible one of the position information centers 18, 20 through the Internet network 16, in this embodiment (FIG. 3) the position information center 20 of an electricity company is selected. The position code is used for searching the position information by the position information center 20.

Also, an information transmitting section 56 transmits the position information notified from the position information center 18 or 20 to the mobile terminal device 2.

A position information search section 58 at the position information center 20 searches position information by using an identification code transmitted from the base station 10 through the Internet network 16 (FIG. 1), namely by using the extracted position code. In this position information search, position information corresponding to the identification code is searched from the position information conversion server 26 by using the position code as address information. The search result is transmitted to the controller 52 of the base station 10 through the position information search section 58. In this case, billing information such as service charge required for the search is calculated at a billing calculation section 60, and then transmitted to the controller 52 through the position information search section 58.

The billing information and the client's information are verified at the base station 10 for notifying to the management center 14 by each client, billing to the client and collecting the bill from the client. The collected fee is then paid to the position information center 20 side through the management center 14.

In the above processing, the position information center 20 is selected as an administrator of position information based on an administrator code, however, in the case where the position information center 18 is selected based on the administrator code, the similar processing is performed by the position information center 18 and the management center 14.

Fees on the position information search for the client may be collected, by converting amount of services to that of fee collection and charging for billing information of a mobile terminal device specific data.

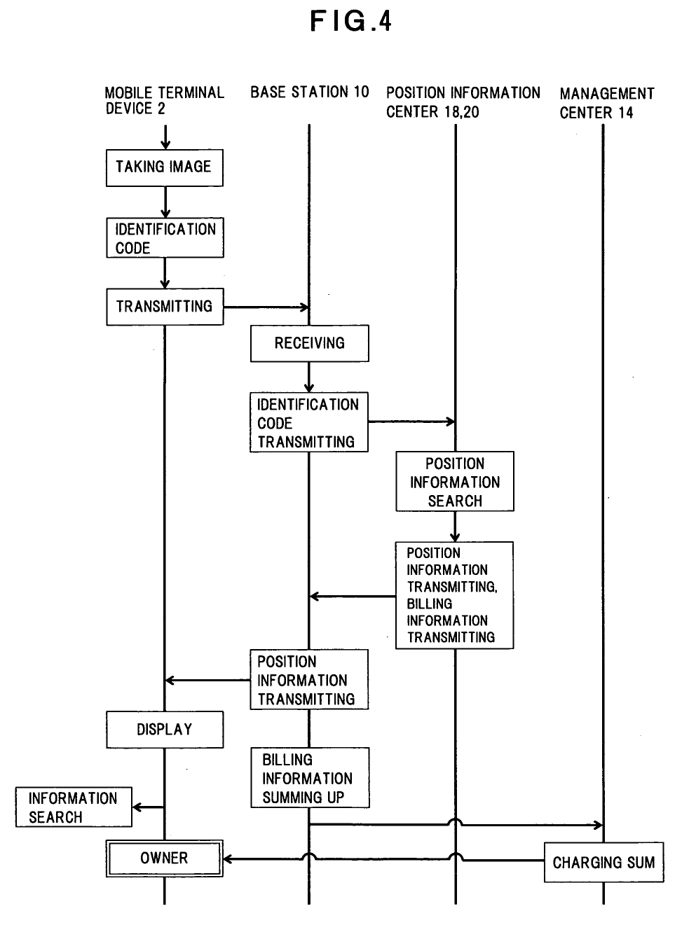

Next, position information search through the medium of an image data is described referring to FIG. 4. FIG. 4 is a flow chart of search function of the position information though the medium of an image data.

In the mobile terminal device 2, upon taking in an image data from the identification mark 6 of construction products 4, etc., an identification code consisting of character information is extracted from the image data and transmitted to the base station 10 together with a client data. The base station 10 receives the identification code and the client data, etc., selects an administrator based on the identification code after a position code and a client are specified, and transmits the identification code and the client data to selected position information center 18, 20 or information-providing center 22. In the position information center 18, 20 or the information-providing center 22 that received the identification code, etc., position information is searched based on the identification code or the position code, and transmitted to the base station 10 together with the billing information. The position information is displayed on the display unit 30 of the mobile terminal device 2 from the base station 10, and can be confirmed by the display unit 30. This position information is re-transmitted to the base station 10 from the mobile terminal device 2, and used to search related information at the information-providing center 22. The user is provided with the position information and its related information such as a map information, a residence indication information, a weather information and a living-related information on hotels and restaurants, etc.

The billing information is summed up for every client at the base station 10, and is notified to the management center 14. The management center 14 converts the billing information to telephone bill and then charges the sum for an owner. In this case, it is also possible to collect the charge automatically from the client's bank account. The collected charge is then paid to the position information center 18, 20 or the information-providing center 22 as a search service fee.

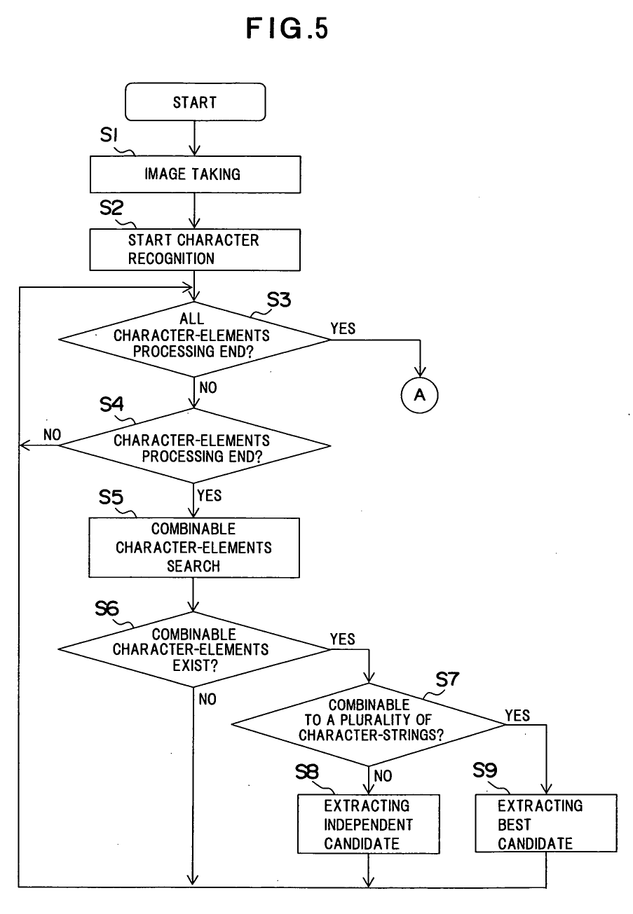

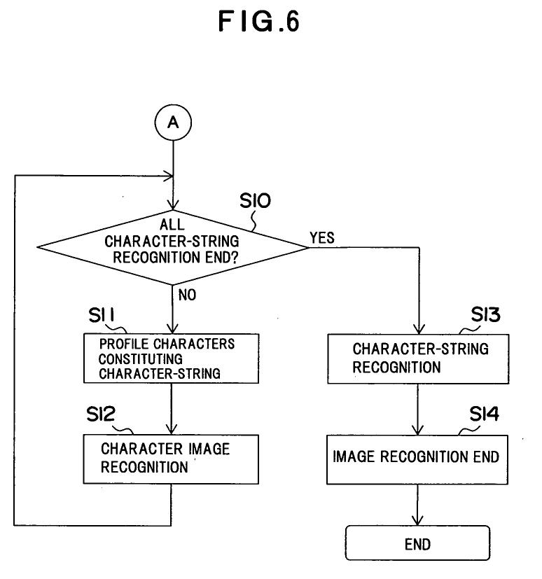

Next, image recognition process is described referring to FIG. 5 and FIG. 6. FIG. 5 and FIG. 6 are flow charts showing image recognition process of identification mark. Marking \textcircled{A} indicates a connector for connecting between the flow chart of FIG. 5 and that of FIG. 6.

An image data of the identification mark 6 is taken in the image input section 8 (Step S1), character recognition from character elements included in the taken image data is started (Step S2). It is determined whether all character elements in the image were processed (Step S3), in case that the process for all character elements are not completed, it is determined whether character element was processed (Step S4), the processes of Step S3 and S4 are continued until all character elements are processed.

In case that the character element was processed, combinable character element is searched out of the recognized characters (Step S5), it is determined whether a combinable character elements exist or not (Step S6). In this case, “combination” includes uniting between elements constituting a character, uniting of independent characters, etc.

In case that there exists combinable character element, it is determined whether the combinable character element can be combined with a plurality of character-strings or not (Step S7). In case that the combinable character element can not be combined with a plurality of character-strings, an independent candidate is extracted (Step S8), In case that the combinable character element can be combined with a plurality of character-strings, the best candidate is extracted (Step S9).

In case that all character elements were processed (Step S3), it is determined whether character recognition of all character-strings is completed or not (Step 10, FIG. 6). In case that the character recognition of all character-strings is not completed, a character constituting the character-string is profiled (Step S11), a character image is recognized (Step S12), and process returns to Step S10. In case that the character recognition of all character-strings is completed, the character-string is recognized (Step S13), and the image recognition process is completed (Step S14).

As a result of the above processing, an identification code necessary for position search and a character or character-string as its related information are obtained from the recognized image of the bar-code 32, the character 34, etc.

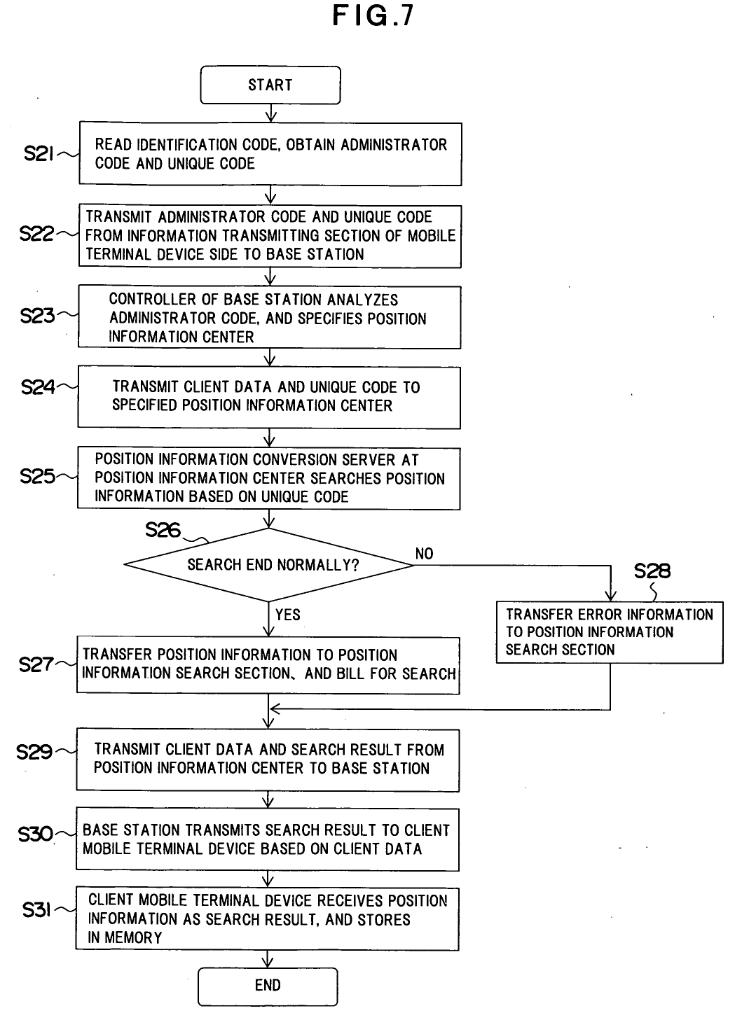

Next, position search process is described referring to FIG. 7. FIG. 7 is a flow chart showing position search process.

According to this position search process, position is searched based on reading an identification code from scanned bar-code 32, etc. An identification code is read from the bar-code 32, etc., in this case, to obtain an administrator code and an unique code of the bar-code 32, etc (Step S21). The administrator code and the unique code are transmitted from the information transmitting section 46 of the mobile terminal device 2 side to the base station 10 (Step S22). At the base station 10, the administrator code is analyzed by the controller 52 to specify the position information center 18 or 20 (Step S23). A client data and a unique code are transmitted from the base station 10 to the specified position information center 20 (referring to FIG. 3) (Step S24). At the position information center 20, position information is searched by the position information conversion server 26 on the basis of the received unique code (Step S25).

In this search, it is determined whether the search is completed normally or not (Step S26), in case that the search is completed normally, searched position information is transferred to the position information search section 58 from the position information conversion server 26 and the search is billed(Step S27) In case that the search is not completed normally at step S26, error information is transferred to the position information search section 58 as a search result (Step S28).

The search result such as the searched position information, etc. is transmitted to the base station 10 from the position information center 20, with attaching the search result to the client data (Step S29). Based on the client data, the search result is notified to the mobile terminal device 2 of the client from the base station 10 for being displayed on the display unit 30 of the mobile terminal device 2 (Step S30). The position information as the search result is received at the mobile terminal device 2 and stored in the memory 44 (Step S31). In this case, even though the search is not completed normally, the error information is notified to the mobile terminal device 2 and displayed on the display unit 30.

Regarding the search method and search system of position information according to the above described embodiment, not only their features, advantages and effects but also other embodiments will be described by listing hereinbelow.

(1) Advantages of the above Embodiment

In the searching method and searching system, making use of an existing image sensor and photography techniques, a bar-code and an image data of characters are converted to electronic data as numeric terms, so that an identification code is recognized. The recognized identification code is transferred to the position information conversion server and converted to position information by searching information on the server. A charge is collected by charging for every user in the position information conversion.

In such searching method and searching system, an affordable mobile terminal device can be used since the GPS radio wave is not used, and moreover existing position information can be utilized. In addition, the position information conversion server can provide with information such as restaurants, maps, stores, and amusements, as regional information and information related to daily life. Furthermore, it is possible to provide with timely information within the position information and cooperate with real time information such as bulletin boards. And the position information resides in the server, so that identification information such as bar-code can be easily modified for the revision and the latest information can be provided. It is also possible to notify the third party the position information. Also, service business can be supplied by investigating and analyzing various demand of service.

(2) Mobile Terminal Devices

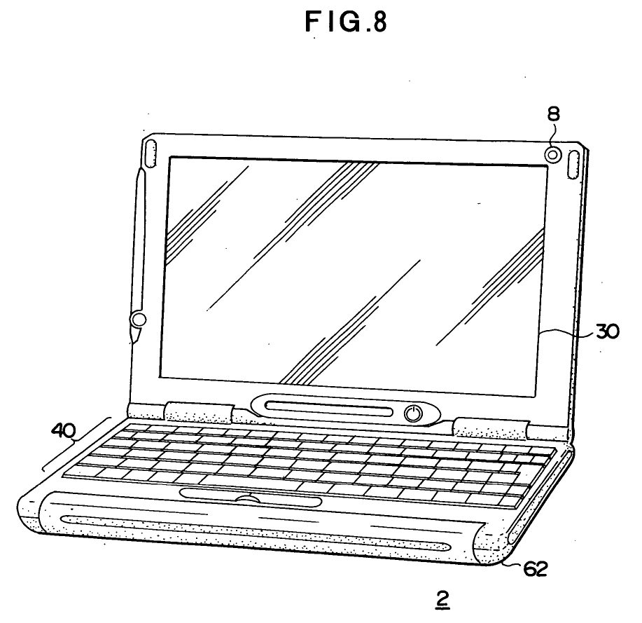

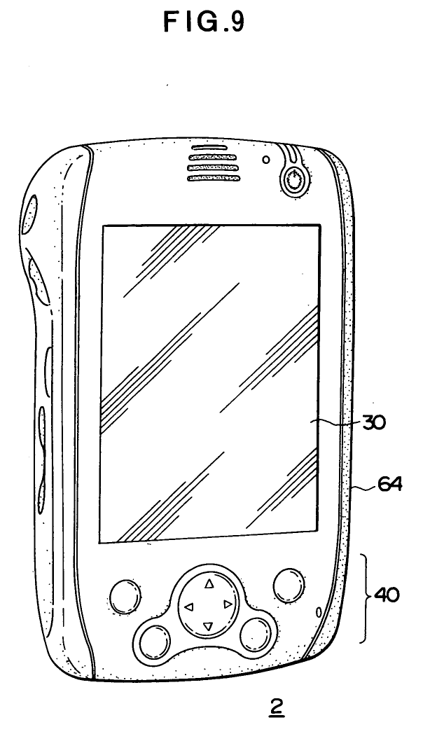

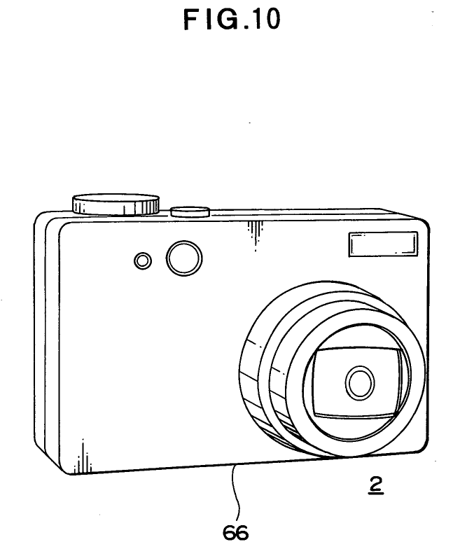

In the above-described embodiment, the mobile phone terminal is exemplified as a mobile terminal device, though, a personal computer (PC) 62 can be used as shown in FIG. 8 and a personal digital assistant (PDA) 64 can be used as shown in FIG. 9. What is more, a digital camera 66 can be as shown in FIG. 10. By adding a telephone function or a telecommunication facility, the digital camera 66 can communicate with the base station 10 like the mobile terminal device 2. Descriptions for the PC 62 and the PDA 64 are omitted by numbering same reference numerals to the same portion as the mobile terminal device 2. Even if such the PC 62, the PDA 64 and the digital camera 66 may be used as a mobile terminal device, the position information can be obtained similarly from an image taken a picture of the identification mark 6.

(3) Processing of Image Data and Selection of Position Information Center

In the above embodiment, an image data taken by the mobile terminal device 2 is converted to an identification code being character information, and then transmitted to the base station 10. However, the image data may be transmitted to the base station 10 from the mobile terminal device 2, and processed at the controller 52 for extracting the identification code and an administrator code from the image data and selecting an administrator of the position information based on the extracted administrator code.

In this case, as selection methods of the position information center 18, 20, etc., there are a method of extracting an administrator code from an image process data by mounting an identification table of position information center in the mobile terminal device 2, and a method for user to select a position information center.

(4) Input Form of an Identification Code

In the above embodiments, an image data is obtained from the image input section 8 by taking a picture. However, an image data may be taken into the mobile terminal device 2 from other information processing device. Also, an identification code may be directly inputted from the input section 40.

(5) Other Modifications

In the above described embodiments, Internet network 16 is used. However the present invention is not limited to the embodiment using Internet network 16. As for information conversion, as form of information being provided in relation to position information, any form of a map, a Uniform Resource Location (URL) such as addresses of homepages in the periphery, voice, a text data, a mail data, a bulletin board system, etc. may be used, and these information may be used together.

According to the present invention, position information is searched and provided through the medium of an image data of an identification mark attached to objects such as construction products and trees, hence position information can be searched even at an area which can not receive a GPS radio wave. Thus position search with high convenience can be realized.

Although the most preferred embodiments of the present invention have been described hereinabove, the present invention is not intended to be limited to the description and can naturally be modified or changed by one skilled in the art based on the gist of the present invention defined in claims or disclosed in the specification, and it is needless to say that such modifications and changes are within the scope of the present invention.

What is claimed is:

1. A searching method of position information, comprising the steps of:
taking an image data of an identification mark attached to an object, and reading an identification code from said image data;
searching position information based on said identification code; and
transmitting said position information acquired by the search.

2. The searching method of position information of claim 1, further comprising the step of:
searching related information of said position information based on said position information, and transmitting the search result.

3. A searching system of position information using a mobile terminal device, comprising:
a mobile terminal device, which takes an image data of an identification mark attached to an object, reads an identification code from said image data and transmits said identification code;
a position information search section, which searches position information based on said identification code transmitted from said mobile terminal device; and
a transmitting section, which transmits said position information searched by said position information search section to said mobile terminal device.

4. A searching system of position information, comprising:
a mobile terminal device, which takes an image data of an identification mark attached to an object, reads an identification code from said image data and transmits said identification code;
a position information search section, which searches position information based on said identification code; and
a base station, which transmits said identification code transmitted from said mobile terminal device to said position information search section, and receives said position information searched by said position information search section and transmits said position information to said mobile terminal device.

5. The searching system of position information of claim 3, wherein said position information is indicated on a display unit of said mobile terminal device.

6. The searching system of position information of claim 4, wherein said position information is indicated on a display unit of said mobile terminal device.

7. The searching system of position information of claim 3, wherein said position information is able to be transferred together with information other than said position information from said mobile terminal device.

8. The searching system of position information of claim 4, wherein said position information is able to be transferred together with information other than said position information from said mobile terminal device.

9. The searching system of position information of claim 3, wherein said position information is converted into an address of homepage.

10. The searching system of position information of claim 4, wherein said position information is converted into an address of homepage.

11. The searching system of position information of claim 3, further comprising:
a related information transmitting section, which searches related information based on said position information, and transmits the search result.

12. The searching system of position information of claim 4, further comprising:
a related information transmitting section, which searches related information based on said position information, and transmits the search result.

13. The searching system of position information of claim 3, wherein said position information search section transmits billing information together with said searched position information to a base station.

14. The searching system of position information of claim 4, wherein said position information search section transmits billing information together with said searched position information to the base station.

15. A mobile terminal device, comprising:
an image processing section reading an identification code from an image data of an identification mark attached to an object;
an information transmitting section transmitting said identification code read by said image processing section; and
an information receiving section receiving position information searched on the basis of said identification code.
